(19) United States
(12) Patent Application Publication
(10) Pub. No.: US 2012/0305101 A1
(43) Pub. Date: Dec. 6, 2012

(54) MULTI-PORT TIRE VALVE

(75) Inventor: Zachary A. Merrill, Greenville, SC (US)

(73) Assignees: SOCIETE DE TECHNOLOGIE MICHELIN, Clermont-Ferrand (FR); MICHELIN RECHERCHE ET TECHNIQUE S.A., Granges-Paccot (CH)

(21) Appl. No.: 13/149,257

(22) Filed: May 31, 2011

(51) Int. Cl. F16K 15/20

(52) U.S. Cl. 137/223

(57) ABSTRACT

Exemplary embodiments of the invention include a multi-port valve stem configured for operable attachment to a wheel for controlling the inflation of a tire arranged thereon. In a particular embodiments, the valve includes a base member having a bore extending there through. The base member includes a terminal end configured to attach the valve stem within an aperture arranged along a wheel rim. The multi-port valve stem further includes one or more tubular ports each having a bore extending there through and arranged in fluid communication with the bore of the base. The bore of each of the one or more tubular ports extends to a free end configured to receive a check valve. In other embodiments, the multi-port valve is mounted to a wheel.

### BACKGROUND OF THE INVENTION

1. Field of the Invention

This invention relates to a valve stem for inflatable items such as pneumatic tires. More particularly, this invention relates to a valve stem having a plurality of access ports. Even more particularly, this invention relates to a tire valve stem having a plurality of access ports in fluid communication with each other that feed into a single access point through a wheel upon which a tire is mounted.

2. Description of the Related Art

Pneumatic tires have been used for an extended period of time on various vehicles such as automobiles and trucks. Pneumatic tires are typically mounted on a wheel having valve stem, the valve stem extending through a provision or hole arranged within in the wheel. The valve stem facilitates tire inflation with a gas, such as air or nitrogen, as well as deflation thereof. The valve stem may also be employed to monitor the tire inflation pressure by applying a pressure gauge to the valve stem.

Presently, commercially-available wheels are configured to only receive a single valve stem having a single port for communicating gases into and from a tire inflation chamber. However, there are instances when additional valve stem ports may be useful when the existing valve stem port is in use.

For example, multiple valve stem ports are desirable when reversibly mounting a tire/wheel assembly on a vehicle. This may be desired when attempting to prolong a tire's useful life, such as when tires wear more rapidly toward one shoulder or the other due to vehicle design and/or road design factors. If one were able to remove a wheel/tire assembly and simply reinstall it in the reverse orientation without dismounting the tire, essentially “rotating the tire,” tire wear life may be substantially extended. This would also avoid having to dismount a tire from a wheel, which requires additional labor, time, and expense—and which may lead to unnecessary tire damage. However, because a valve stem is typically arranged on a single side of a wheel, reversibly mounting a wheel on a vehicle may significantly hinder valve stem access.

By further example, another drawback of traditional single valve stem wheels concerns the use of Central Tire Inflation Systems (CTIS). Central tire inflation systems typically affix an inflation hose to a tire's valve stem. With this hose in place, the valve stem is inaccessible for other needs, such as to check the tire's inflation pressure, whether manually or by way of an automatic pressure-monitoring device.

In yet another example, various over-the-road trucks and tractor-trailers utilize dual wheel arrangements, whereby two wheels are installed side-by-side on a single side of an axle. In use, however, the inflation pressure of each tire installed on the dual wheels may vary. Therefore, dual tire equalizers may be used to balance the tire pressures. In operation, the dual tire equalizers comprise a hose extending between valve stems of each tire to provide a pathway for air to transfer between the adjacent tires. However, when utilizing dual tire equalizers, the single vale stem port along each wheel is used, which prevents the concurrent use of a central tire inflation system or the convenient ability to concurrently use a pressure gauge to independently verify a tire's inflation pressure without disconnecting the tire equalizer.

Therefore, there is a need for a multi-port valve stem for arrangement on a tire wheel.

### SUMMARY OF INVENTION

It is an aspect of the claimed invention to provide a valve stem for a pneumatic tire which can accommodate a plurality of ports on a single valve stem. In a particular embodiment, the valve stem comprises a base member having a bore extending there through, the base member including a terminal end configured to attach the valve stem within an aperture arranged along a wheel rim. Said valve stem may further include a first tubular shank having a bore extending there through. The bore of the first shank is arranged in fluid communication with the bore of the base member and extending to a free end of the first shank. The free end of the first shank is configured to receive a check valve. Said valve may also include a second tubular shank having a bore extending there through, the bore of the second shank arranged in fluid communication with the bore of the base member and extending to a free end of the second shank, and the free end of the second shank configured to receive a check valve.

More generally, in other embodiments, the valve stem comprises a base member having a bore extending there through, the base member including a terminal end configured to attach the valve stem within an aperture arranged along a wheel rim. The valve stem further includes a plurality of tubular ports each having a bore extending there through and arranged in fluid communication with the bore of the base, the bore of each of the one or more tubular ports extending to a free end configured to receive a check valve.

In particular embodiments, any valve stem described in the preceding paragraphs is attached to a pneumatic tire wheel comprising an annular rim and a disk extending radially outward relative a rotational axis of the wheel to engage the annular rim. The multi-port valve stem may be arranged through an aperture in the rim.

The foregoing and other objects, features and advantages of the invention will be apparent from the following more detailed descriptions of particular embodiments of the invention, as illustrated in the accompanying drawings wherein like reference numbers represent like parts of the invention.

### BRIEF DESCRIPTION OF THE DRAWINGS

FIG. 1 is a partial sectional view of a multi-port valve stem according to an exemplary an embodiment of the present invention.

FIG. 2 is a sectional view of a multi-port valve stem according to an alternative embodiment of the present invention.

FIG. 3 is a sectional view of a multi-port valve stem according to a second alternative embodiment of the present invention.

FIG. 4 is a sectional view of a multi-port valve stem according to an alternative embodiment of the present invention.

FIG. 5 is a partial cross sectional view of an annular tire wheel showing a multi-port valve stem arranged thereon, a port of the valve stem extending through an aperture in the wheel disc such that a user or device may access the valve stem from both lateral or axial sides of the wheel, which would allow the wheel to be reversibly mounted on a vehicle, in accordance with a particular embodiment of the invention. The rotational axis of the wheel is represented by line A-A in the Figure.

FIG. 6 is a partial cross sectional view of a dual wheel arrangement, one of the tire/wheel assemblies including a multi-port valve stem having a port attached to a dual tire pressure equalizer extending from the multi-port valve stem of a first wheel to a valve stem arranged along a second wheel of the dual wheel arrangement, in accordance with a particular embodiment of the invention. The rotational axis of the wheel is represented by line A-A in the Figure.

FIG. 7 is a partial cross sectional view of an annular tire wheel showing a multi-port valve stem arranged thereon, the valve stem having three ports, a first port being operably connected to a tire inflation system, a second port being operably attached to a pressure monitoring device, and a third port remaining unused to provide immediate accessibility to the tire inflation chamber by any user or device, in accordance with a further embodiment of the invention.

### DETAILED DESCRIPTION OF PARTICULAR EMBODIMENTS

The present invention is directed toward a multi-port valve stem comprising a plurality of ports extending outwardly from a common base configured for attachment to a tire wheel. Each port is configured to include a check valve to control the inflation of a corresponding tire. The invention will be better understood with reference to the following examples which are included for purpose of illustration and not limitation. The following examples, therefore, should not be viewed as limiting the scope of the invention.

Generally, the multi-port valve stem comprises a base member and at least first and second ports. Ports generally form shanks or legs extending outwardly from the valve stem. The base member and the first and second ports each include a bore or fluid passage extending there through. The bore of the first and second ports are in fluid communication with the bore of the base member. The base member includes a terminal end configured to attach the valve stem within an aperture arranged along a wheel rim. Each of the first and second ports extending outwardly to a free end. Each free end is configured to receive a check valve. In further variations, the valve stem may additionally include a third port containing a bore extending there through that is also in communication with the bore of the base member and is configured to receive a check valve at a free end of the third port. The base and the first and second ports are tubular in particular variations.

It can also be said that the multi-port valve stem includes a base member as described above and a plurality of tubular ports or shanks each having a bore extending there through. Such ports are arranged in fluid communication with the bore of the base. Further, the bore of each of the one or more tubular ports extends to a free end configured to receive a check valve.

In particular embodiments, the valve stem also includes a means for attaching or securing the valve stem to a wheel. Said means may comprise any known means for attaching or securing any known valve stem to a wheel. For example, means for securing the valve stem to a wheel comprises a flange extending outwardly from a side of the base member, the flange being spaced a distance from the terminal end to engage an outer side of a wheel in a secured arrangement. The terminal end is also threaded to receive a retaining nut for arrangement along an inner side of the wheel opposite the flange. The means for attaching also forms a seal between the valve stem and the wheel. This may be achieved by arranging an o-ring or other sealing member between the valve stem and the wheel.

The multi-port valve stem of the present invention is configured to be used with, and mounted to, a tire wheel. In particular, the valve stem is configured to be inserted through an aperture arranged in the wheel rim and to which the valve is mounted. The valve stem is arranged on the wheel for fluid communication with an inflation or pressurization chamber of a pneumatic tire mounted on the wheel. The wheel generally comprises a rim for receiving a tire, the rim extending annularly to form a ring about a central disk extending in a generally radial direction relative a rotational axis of the wheel, the rotational axis extending centrally through said disk. The disk may be further configured for mounting the wheel to a rotational hub of a vehicle.

In particular embodiments, where the multi-port valve stem is mounted on one axial side of the wheel disk, a port of the valve stem is arranged relative an aperture in the disk for easy access by a user or device from the other axial side of the disk. In such arrangements, the free end of such port is closely arranged relative the aperture in the wheel disk. In particular instances, the free end is arranged within the aperture or extends partially or fully through the aperture to a side of the disk opposite the valve stem. This may be particularly useful when desiring to reversibly mount the wheel to a vehicle, as each side of the disk has an accessible valve stem port.

Multi-port valve stems are also useful regardless of whether any port extends through a wheel disk when there are multiple purposes for simultaneously accessing the tire inflation chamber. For example, Central Tire Inflation Systems (CTIS) are used to inflate and maintain tires at a desired pressure. There are also tire pressure monitoring systems that alert a driver or fleet supervisor of any low inflation occurrences. Because these systems and devices may not perform the same functions, it may be desired to simultaneously employ independent inflation devices pressure monitoring devices. It may also be desired, when employing any such device, to provide an unused port that may be accessed for manual inflation or deflation operations or manual pressure monitoring, such as to independently verify the proper operation of any automatic device.

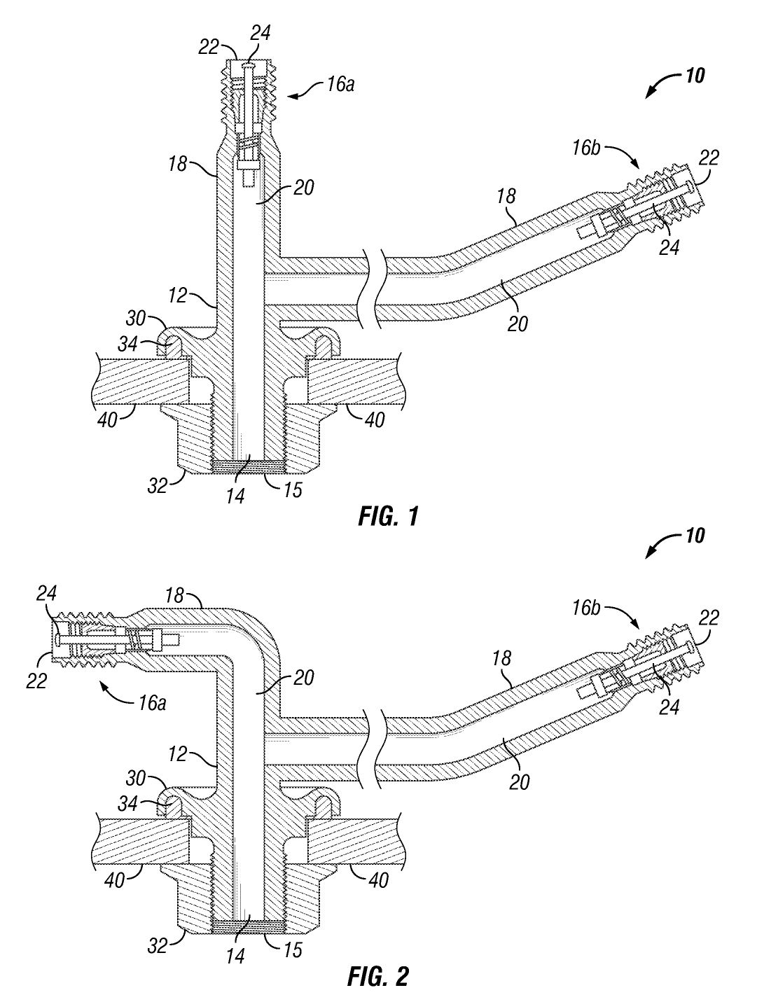

The multi-port valve stem generally discussed above will now be more fully described in association with the drawings, which are not meant to be limiting but rather used to generally describe the invention in accordance with particular embodiments of the invention. Referring now to FIGS. 1-4, a multi-port valve stem 10 is shown. The valve stem 10 includes a base member 12 configured to be received within an aperture 14 of a wheel, and more specifically an annular rim 40 of said wheel. Base member 12 includes a terminal end 15 configured for communication with a wheel. A bore 14 extends from terminal end 15 and through base member 12 to communicate pressurized gas between an inflation chamber of the tire and one of a plurality of ports 16a, 16b, 16c in fluid communication with the base member. Ports 16a, 16b, 16c are also referred to herein as “shanks”. Each port 16a, 16b, 16c includes a corresponding free end 22 from which a bore 20 extends, the bore 20 being in fluid communication with the bore 14 of base member 12.

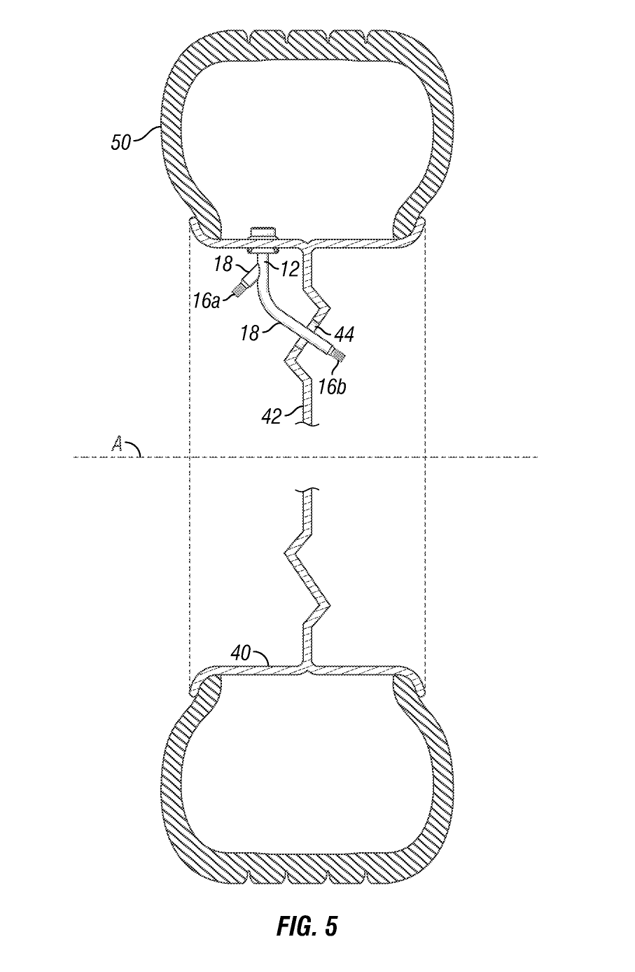

As exemplarily shown in FIGS. 1-2, a housing 18 generally surrounds each bore 20. Each housing 18 shown is generally tubular in form, but in other arrangements housing may comprise any shaped or sized structure. Housing 18, as well as base member 12, may be formed of any one or more materials, such as steel, aluminum, or plastic. The housing 18 of each port is integral with base member 12, and may be arranged to be unitary therewith by any known forming or joining process, such as molding, welding, or use of permanent joining compounds. Fasteners or other mechanical means may also be used to assemble ports 16a, 16b, 16c in sealed communication with base member 12. Such processes and means may also be employed to arrange one port 16a, 16b, 16c along another port, which is exemplary shown in FIG. 4, where such ports are together in fluid communication with bore 14 of base member 12.

With continued reference to FIGS. 1-2, each free end 22 includes a check valve 24, which may comprise any known valve employed in the tire industry to permit selective inflation and deflation of a tire. For example, check valves 24 are Schrader valves as generally shown in the figures, but may instead comprise Presta or Dunlop valves, each of which are commonly used check valves in the tire industry. While the check valves 24 are configured to permit selective inflation and deflation, the valves are also configured to prevent unintended deflation of tires. In a particular embodiment, all valves 24 arranged within valve stem 10 arrangement are of the same type. However, in the alternative, different valves types may be arranged concurrently in different ports 16a, 16b, 16c as desired for a particular purpose. To facilitate installation of a check valve, an interior portion of housing 18 may be threaded near the free end to removably install a check valve 24 having corresponding threading. Further, an outside surface of the housing 18 near each free end 22 may also be threaded to receive a cap (not shown) to protect the check valve 24 when not being accessed by any user or device.

Base member 12 includes a means for attaching or securing the valve stem to the wheel. While such means may comprise any known means, in the embodiments shown in FIGS. 1-4 the means comprises a flange 30 extending outwardly from a side of the base member 12. To facilitate attachment of the valve stem 10 to a wheel in a secured arrangement, the flange 30 is spaced a distance from the terminal end 15 to engage an outer side of a wheel in the secured arrangement. Terminal end 15 is threaded to receive a retaining nut 32 for arrangement along an inner side of the wheel opposite flange 30. Valve 10 may further include a means for sealing the valve along a wheel to prevent the release of any pressurized gas from the tire inflation chamber. Any means of sealing a valve to a wheel that is known in the art may be employed by valve 10. In the examples shown, sealing means comprises an annular seal 34 arranged between flange 30 and the wheel. Such seal may be formed of any suitable material, such as a compressible or elastomeric material.

By providing two or more ports 16a, 16b, 16c within a single valve stem 10, the inflation pressure of a pneumatic tire may be concurrently accessed for different purposes. For example, the single valve stem permits simultaneous inflation control and pressure monitoring by utilizing the valve stem arrangement of the present invention. In a particular instance, a first port 16a may be attached to a central tire inflation system while a second port 16b is used to monitor the inflation pressure, whether by automatic or manual means.

It is also appreciated that providing multiple ports 16a, 16b, 16c permits a wheel to be mounted in an inverse arrangement while providing continued easy access to the valve stem. In such instances, one of the ports 16a, 16b, 16c is arranged in close relation to an aperture 44 arranged in a wheel disk 42 extending generally radially outward to engage the rim 40, which is generally shown in FIG. 5. While the valve stem is mounted on one lateral or axial side of the central wheel disk 42, the aperture 44 permits access to a closely arranged port 16a, 16b, 16c from the other side of disk 42. In this arrangement, the free end 22 of the closely arranged port may remain on the same side of the wheel as valve stem 10 is mounted, or may partially or fully extend through the aperture 44 for arrangement on the other lateral side of disk 42, which is shown in FIG. 5.

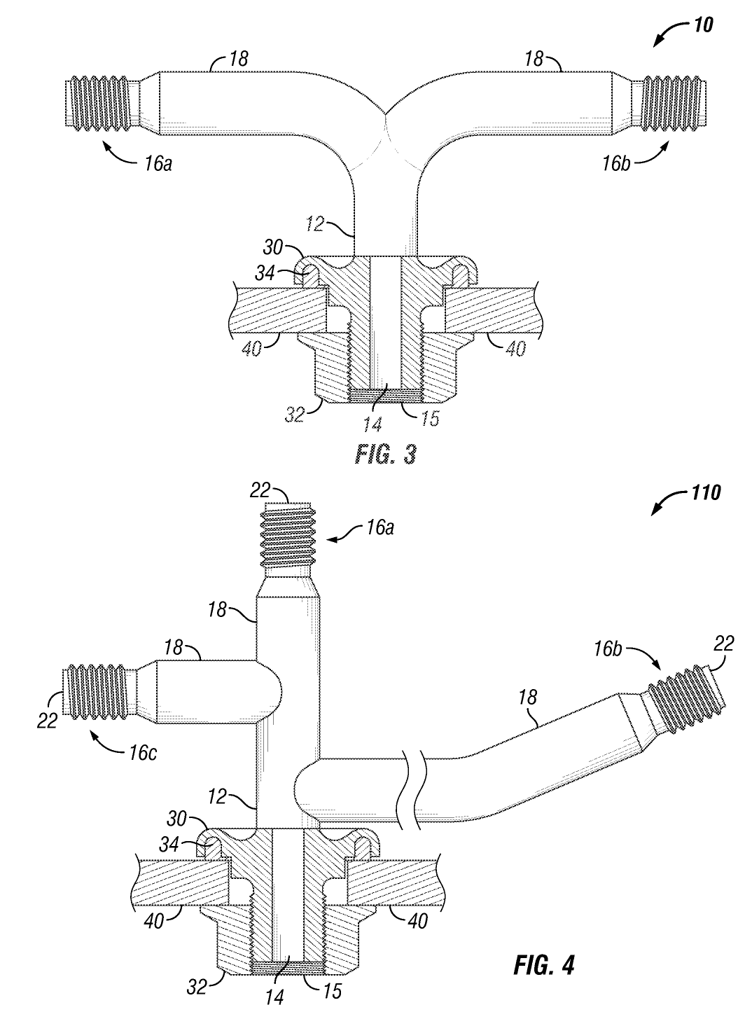

To facilitate a desired use of the multi-port valve stem 10, the configuration of ports 16a, 16b, 16c may vary as desired according to the particular needs of a specific application. Accordingly, each port may extend outwardly in any direction desired relative to base member 12 and any other port arranged within the valve stem 10. For example, with reference to FIG. 1, a first port 16a extend in a radial direction of the wheel, with a second port 16b extending perpendicularly and then bending at an angle along its length away from the wheel. In another example, with reference to FIG. 2, first port 16a extend in a radial direction of the wheel, but then includes a 90 degree elbow such that the remaining length extends in an axial direction of the wheel. Second port 16b in FIG. 2 is similar to the second port of FIG. 1. In the example shown in FIG. 3, each port 16a, 16b extends from base 12 in a sweeping curvilinear path to form a 90 degree elbow. Relative to the 90 degree elbow shown in FIG. 2, the elbow of FIG. 3 extends about a larger radius than the elbow of FIG. 2.

As it is understood that the multi-port valve stem 10 may include any multitude of ports, with reference to FIG. 4, valve stem 110 includes three ports 16a, 16b, 16c. Valve stem 110 resembles the valve stem 10 of FIG. 1, with the exception of now including a third port 16c. While the third port 16c may be arranged at any location along valve stem 110, third port 16c may extend from first port 16a at a right angle such that the third port extends perpendicularly relative the first port 16a. Accordingly, bore 18 of the third port 16c intersects bore 18 of the first port 16a. Because bore 18 of the first port is in fluid communication with base member bore 14, the third port bore is also in fluid communication with base member bore. In accordance with the invention, additional ports may be added to valve stem 110 as desired to achieve a particular purpose.

It should be noted that the ports are not limited to the shapes and arrangements shown in the Figures. This is because the ports 16a, 16b (and 16c) and associate housings 18 may be formed into any convoluted shape and arranged as desired to avoid or navigate any obstacle located on or near the wheel or to otherwise achieve any desired purpose. Therefore, any port or housing may extend in any linear, curvilinear, or non-linear path as desired.

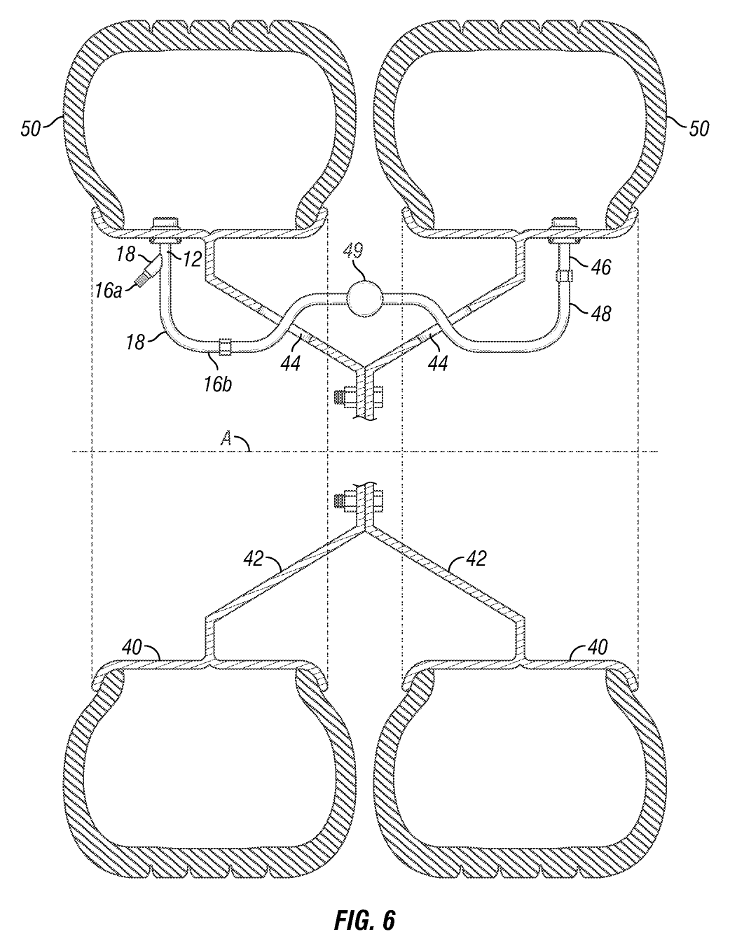

Based upon the foregoing, an exemplary use of the multi-port valve 10 is described in association with FIG. 6, which provides a dual wheel arrangement. In this arrangement, a multi-port valve stem 10 is arranged along a first wheel and an ordinary valve stem arranged along a second wheel. With regard to the multi-port valve stem, first and second ports 16a, 16b are provided. First port 16a remains unused for possible use by a manual or automatic pressure monitoring device or inflation device while second port 16b is also provided and connected to a multi-tire inflation pressure equalizer 48 for the purpose of balancing the inflation pressures of each corresponding tire 50. The pressure equalizer places multiple tires in fluid communication such that the inflation pressure of each tire is equalized amongst all connected tires. These pressure equalizers commonly employ a valve 49 arranged along the fluid passage extending between each tire to prevent the unnecessary deflation of a tire, such as when another tire experiences a leak or blowout. In operation, when a sudden pressure drop in one tire creates a pressure differential between connected tires equal to or greater than a target pressure differential, the valve closes to preserve the air inflation in at least one of the other tires. Otherwise, if a leak were to occur, the pressurized gas in the other tires would continue to communicate with the leaking or blown-out tire in an attempt to equalize. This would ultimately result in complete deflation of all such tires. By utilizing a multi-port valve, a central inflation system or any other inflation control or monitoring device may be more easily used when providing an additional port, which eliminates the need to disconnect the pressure equalizer 48.

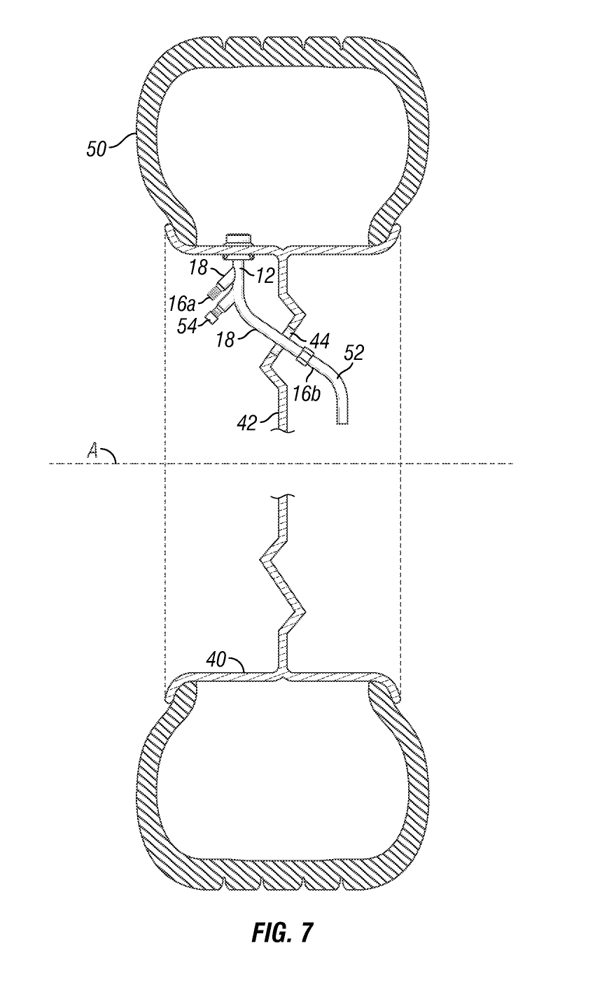

A further exemplary use of the multi-port valve stem is shown in FIG. 7. Such use employs a three-port valve stem 110. In this instance, a first port 16a is operably connected to a tire inflation system via conduit 52. A second port 16b is shown operably attached to a pressure monitoring device 54, the device being arranged to alert a user of a low inflation pressure condition by any known means, such as by visual, audible, or electronic means. Finally, a third port 16c remains free to provide immediate accessibility to a user or device, while the other remaining ports are utilized by the stated devices.

As further exemplified in the Figures, the present invention provides a wheel equipped with the a multi-port valve stem as generally described above. The claimed invention may be utilized on a variety of standard wheels containing any single valve stem mounting aperture. As generally described in accordance with FIG. 5, the wheel may be a reversible wheel, that is a wheel that may be installed on a vehicle from either lateral or axial side of the wheel.

Based upon the foregoing disclosure, it should now be apparent that the multi-port tire valve arrangement of the claimed invention will carry out the objects set forth hereinabove. It is, therefore, to be understood that any variations evident fall within the scope of the claimed invention and thus, the selection of specific component elements can be determined without departing from the spirit of the invention herein disclosed and described.

What is claimed is:

1. A valve stem for inflating a pneumatic tire, the tire valve stem comprising:
a base member having a bore extending there through, the base member including a terminal end configured to attach the valve stem within an aperture arranged along a wheel rim;
a first tubular shank having a bore extending there through, the bore of the first shank arranged in fluid communication with the bore of the base member and extending to a free end of the first shank, and the free end of the first shank configured to receive a check valve; and,
a second tubular shank having a bore extending there through, the bore of the second shank arranged in fluid communication with the bore of the base member and extending to a free end of the second shank, and the free end of the second shank configured to receive a check valve.

2. The valve stem of claim 1, wherein base member includes a means for securing the valve stem to a wheel.

3. The valve stem of claim 2, wherein the means for securing the valve stem to a wheel comprises a flange extending outwardly from the base member, the flange being spaced a distance from the terminal end to engage an outer side of a wheel in a secured arrangement and the terminal end being threaded to receive a retaining nut for arrangement along an inner side of the wheel opposite the flange.

4. The valve stem of claim 3, wherein at the flange is unitary with the base member.

5. The valve stem of claim 1, wherein the check valves are Schrader valves, which are arranged within the free ends of the first and second tubular shanks.

6. The valve stem of claim 1, wherein the first and second tubular shanks are unitary with the base member.

7. The valve stem of claim 6, wherein the first and second tubular shanks and the base member are unitarily formed with each other.

8. The valve stem of claim 1 further comprising:
a third tubular shank having a bore extending there through, the bore of the third shank arranged in fluid communication with the bore of the base member and extending to a free end of the third shank, and the free end of the third shank configured to receive a check valve.

9. The valve stem of claim 1, wherein the valve stem is mounted to a pneumatic tire wheel comprising an annular rim and a disk extending radially outward relative a rotational axis of the wheel to engage the annular rim.

10. The valve stem of claim 9, wherein at least one of the first and second tubular shanks extends through an aperture in the wheel disk.

11. The valve stem of claim 10, wherein the free end of at least one of the first and second tubular shanks is connected to a central tire inflation system.

12. The valve stem of claim 11, wherein the other of the first and second tubular shanks is in fluid communication with a valve stem of a second wheel.

13. The valve stem of claim 12, wherein the fluid communication between the other of the first and second tubular shanks and the valve stem of the second wheel is achieved by a dual tire equalizer.

14. The valve stem of claim 9, wherein the valve stem additionally comprises a third tubular shank having a bore extending there through, the bore of the third shank arranged in fluid communication with the bore of the base member and extending to a free end of the third shank, and the free end of the third shank configured to receive a check valve.

15. The valve stem claim 9, wherein base member includes a means for securing the valve stem to a wheel.

16. The valve stem of claim 9, wherein the check valves are Schrader valves, which are arranged within the free ends of the first and second tubular shanks.

17. A valve stem for a pneumatic tire, the tire valve stem comprising:
a base member having a bore extending there through, the base member including a terminal end configured to attach the valve stem within an aperture arranged along a wheel rim; and,
a plurality of tubular ports each having a bore extending there through and arranged in fluid communication with the bore of the base, the bore of each of the one or more tubular ports extending to a free end configured to receive a check valve.

18. The valve stem of claim 17, wherein the check valves are Schrader valves, which are arranged within the free ends of the first and second tubular shanks.

19. The valve stem of claim 17, wherein the one or more tubular ports are unitary with the base member.

20. The valve stem of claim 17, wherein base member includes a means for securing the valve stem to a wheel.
